(19) United States
(12) Patent Application Publication
(10) Pub. No.: US 2005/0100395 A1
(43) Pub. Date: May 12, 2005

(54) Display binder with offset binding mechanism

(76) Inventor: Michael K. Brann, Hyde Park, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/705,263

(22) Filed: Nov. 10, 2003

(51) Int. Cl. B42F 13/00

(52) U.S. Cl. 402/73

(57) ABSTRACT

A binder including a spine having a first edge and a second edge, a front cover pivotally coupled to the first edge of the spine, and a rear cover pivotally coupled to the second edge of the spine. The front cover is directly or indirectly attachable to the rear cover to form a self-supporting binder. The binder further includes a binding mechanism coupled to the spine, wherein the binding mechanism is coupled to the spine in an off-center manner such that the binding mechanism is located closer to one of the edges than the other one of the edges.

The present invention is directed to a binder with a binding mechanism, and more particularly, to a binder with a binding mechanism that is mounted to a spine in an offset manner.

### BACKGROUND

Binders are widely used as a mechanism for storing loose leaf papers, handouts, and other school and business products. Such binders may be used as a so-called “presentation binder” wherein the binder is folded into a generally triangular or “propped” configuration so that the pages or papers bound in the binder can be easily viewed and displayed. However, many existing presentation binders are merely standard binders which are slightly modified to allow the binder to be folded into the “propped” position. Accordingly such display binders may not be appropriately configured or designed for use as a display binder.

In particular, in most existing display binders the binding mechanism is centered on the spine. However, when papers or pages are to be displayed in such a display binder, the pages may lie over a “fold” or junction of the binder. When a display paper or pages lies over this crease, another crease may appear in the displayed paper or pages, which can distort the paper or pages to be displayed and presents an unpleasing appearance. Accordingly, there is a need for an improved display binder.

### SUMMARY

The present invention is a binder which is specifically configured to be used as a display binder to address the issues with respect to creased display pages described above. In particular, the binding mechanism of the binder may be mounted in an off-center manner relative to the spine so that the binding mechanism is located closer to one of the covers. In this manner, when the papers or pages to be displayed by the display binder of the present invention are bound by the binding mechanism, the papers lay flat against the front cover and are not creased.

In particular, in one embodiment the invention is a binder including a spine having a first edge and a second edge, a front cover pivotally coupled to the first edge of the spine, and a rear cover pivotally coupled to the second edge of the spine. The front cover is directly or indirectly attachable to the rear cover to form a self-supporting binder. The binder further includes a binding mechanism coupled to the spine, wherein the binding mechanism is coupled to the spine in an off-center manner such that the binding mechanism is located closer to one of the edges than the other one of the edges. Other objects and advantages of the present invention will be apparent from the following description and the accompanying drawings.

### BRIEF DESCRIPTION OF THE DRAWINGS

FIG. 1 is a front perspective view of one embodiment of the binder of the present invention, shown in its closed position;

FIG. 2 is a front perspective view of the binder of FIG. 1, shown in its open position;

FIG. 3 is a front perspective view of the binder of FIG. 2, with the extension flap in its open position;

FIG. 4 is an end view of the binder of FIG. 1, illustrating the binder partially folded into its display position;

FIG. 5 is an end view of the binder of FIG. 1, shown in its display position;

FIG. 6 is a detail end view of a portion of the binder of FIG. 5;

FIG. 7 is a detail end view of a binder with a center-mounted binding mechanism;

FIG. 8 is a rear perspective view of the binder of FIG. 5; and

FIG. 9 is a front perspective view of FIG. 5.

### DETAILED DESCRIPTION

The binder of the present invention, generally designated 10, may include a front cover 12, a rear cover 14, and a spine 16 located between the front 12 and rear 14 covers. Each of the front 12 and rear 14 covers may include an inner edge 18 and an outer edge 20. The spine 16 may include first 22 and second 24 edges located on opposite sides of the spine 16. The inner edge 18 of the front cover 12 is coupled to the first edge 22 of the spine 16 to pivotally couple the front cover 12 to the spine 16. Similarly, the inner edge 18 of the rear cover 14 is coupled to the second edge 24 of the spine 16 to pivotally couple the rear cover 14 to the spine 16. In the illustrated embodiment, each of the spine 16 and covers 12, 14 are generally flat, planar components and are generally rectangular in front view.

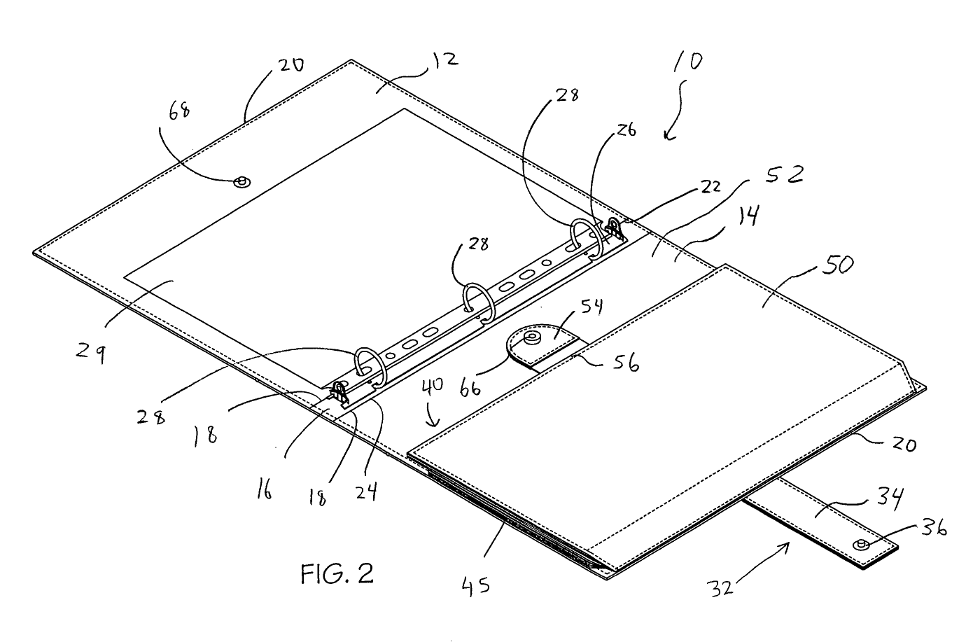

As best shown in FIG. 2, the binder 10 may include a binding mechanism 26 coupled to the spine 16. In the illustrated embodiment, the binding mechanism 26 is a three-ring binding mechanism including a set of three rings 28. Each ring 28 may include a pair of separable prong components that can be separated so that paper, pages, or other inserts can be inserted into the three ring binding mechanism 26 in a well-known manner. FIGS. 2 and 5-8 illustrate a single sheet 29 bound in the binding mechanism 26.

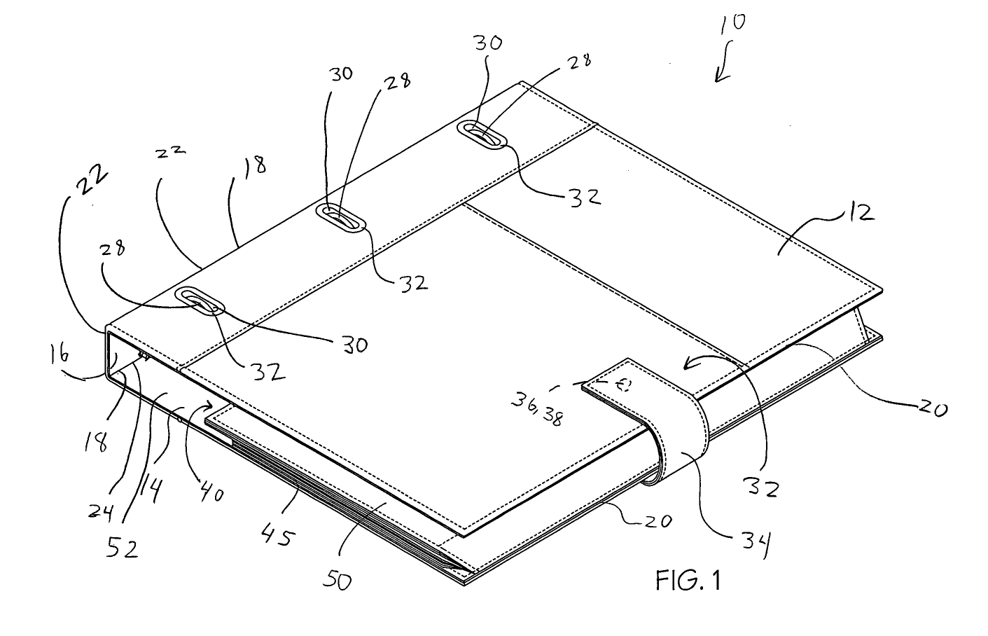

The front cover 12 may include a plurality of openings or slots 30 formed therein (see FIG. 1). Each of the slots 30 may be aligned with one of the rings 28 of the binding mechanism 26 such that the outer edges or peripheries of the rings 28 can be received through the openings 30 when the binder is in its closed position (see FIG. 1). In this manner, when the binder 10 is in its closed position, the binder 10 can assume a more compact position. Each of the openings 30 may have grommets, such as metal grommets, located therein to protect the rings 28 and front cover 12 and thereby increase the durability of the binder 10.

FIG. 1 illustrates the binder 10 in its closed position wherein the front 12 and rear 14 covers are generally parallel and facing each other and wherein the binding mechanism 26 is generally located between the front 12 and rear 14 covers. The binder 10 may include a closure mechanism or closure means 32 to retain the binder 10 in its closed position. For example, in the illustrated embodiment, the closure means 32 includes a strap of material 34 fixedly coupled to the rear cover 14. The strap 34 includes a male snap component 36 thereon (FIG. 2) which is releasably engageable with a female snap 38 component located on the outer surface of the front cover 12. Of course, a wide variety of mechanisms or means for coupling the front 12 and rear 14 covers together may be utilized as the closure means 32, including, but not limited to, hook-and-loop fastening material (i.e., VELCRO®), clasps, brackets, clips, magnets, interengaging geometries, cords, ties and the like.

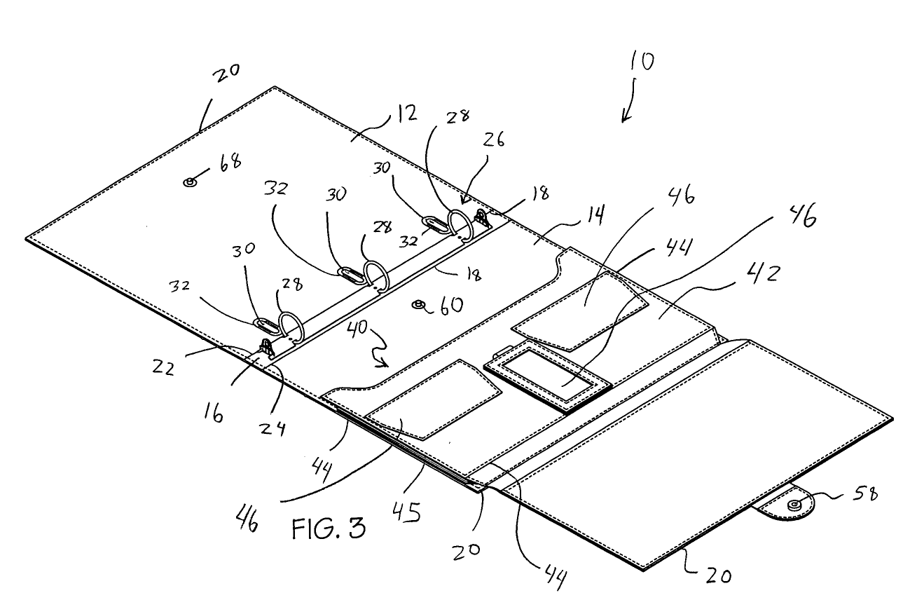

As can be seen in FIG. 3, the binder 10 may include a pocket 40 located on the rear cover 14. In particular, the pocket 40 may be formed by a pocket flap 42 coupled along three of its edges 44 to the rear cover 14. The pocket flap 42 may be coupled to the rear cover 14 by expandable gusset material 45 (i.e., accordion-style material or the like) to provide an expandable pocket 40. Various other, smaller pockets 46 may be located on the pocket flap 42.

Returning to FIG. 2, the rear cover 14 may include an extension flap 50 pivotally coupled thereto, or formed as part of the rear cover 14. In particular, the extension flap 50 may be movable between a closed position wherein the extension flap 50 is generally parallel to and faces the rear cover 14 (FIG. 2) and an open position wherein the extension flap 50 is generally parallel to but does not face the rear cover 14 (FIG. 3). The extension flap 50 is pivotally coupled to a main 52 portion of the rear cover 20, and includes an end portion 54 and an end hinge line 56.

When the extension flap 50 is in its closed position (FIG. 2), the extension flap 50 may generally cover the pocket 40. Furthermore, the extension flap 50 may include coupling means, such as a female snap component 58 (FIG. 3), which is engageable with a male snap component 60 on the rear cover 14. In this manner, when the female snap component 58 of the extension flap 50 is engaged with the male snap 60 component of the rear cover 14, the pocket 40 may be generally covered and compressed to retain the contents therein. Any of a variety of coupling means, including the variety of mechanisms usable as closure means 38 listed above may be used as or in place of the coupling means 58, 60.

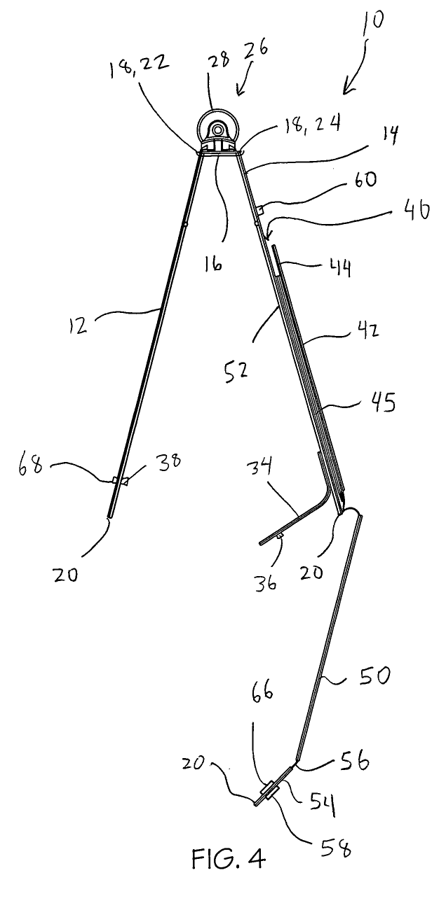

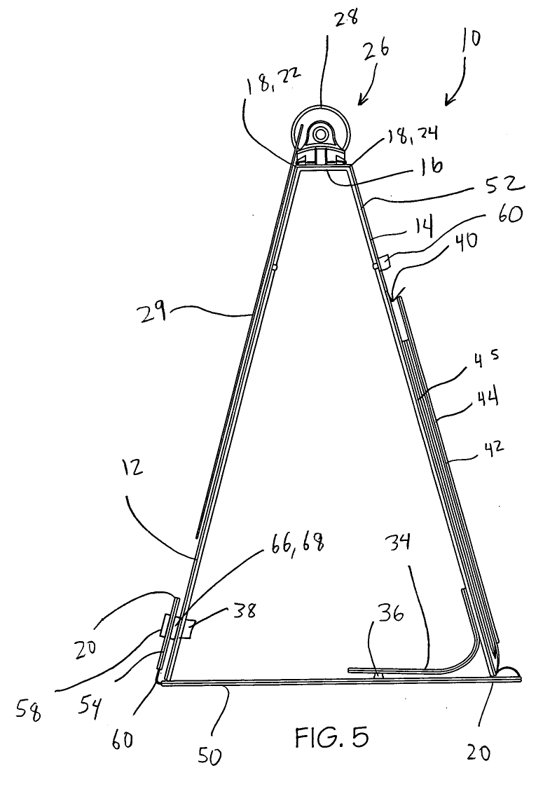

In order to move the binder 10 to its display position, the covers 12, 14 are moved to their open positions and the extension flap 50 is moved to its open position as shown in FIG. 3. Next, the extension flap 50 is folded underneath the front 12 and rear 14 covers, as shown in FIG. 4. The extension flap 50 is then continued to be folded underneath the front 12 and rear 14 covers until the extension flap 50 is located adjacent to or can be coupled to the front cover 12 (FIG. 5). In particular, the extension flap 50 may include a second female snap component 66 on the end portion 54 that is shaped and located to engage a male snap component 68 on the inner surface of the front cover 12 to retain the binder 10 in its display position. In this manner, the binder is movable into its display position (FIG. 5) wherein the front cover 12 is directly or indirectly attached to the rear cover 14 to form a self-supporting binder, and the binding mechanism 26 is not generally located between the front 12 and rear 14 covers. Again, any of a wide variety of attachment mechanisms or attachment means, including, but not limited to, hook-and-loop fastening material, clasps, brackets, clips, magnets, interengaging geometries, cords, ties and the like may be used in place of the snap components 66, 68 without departing from the scope of the invention.

As shown in FIG. 5, when the binder 10 is in its display position, the binder 10 has a generally closed, generally triangular shape in end view. Thus, when the binder 10 is in its display position, the extension panel 50 forms a base of the triangle upon which the display binder 10 can stably rest.

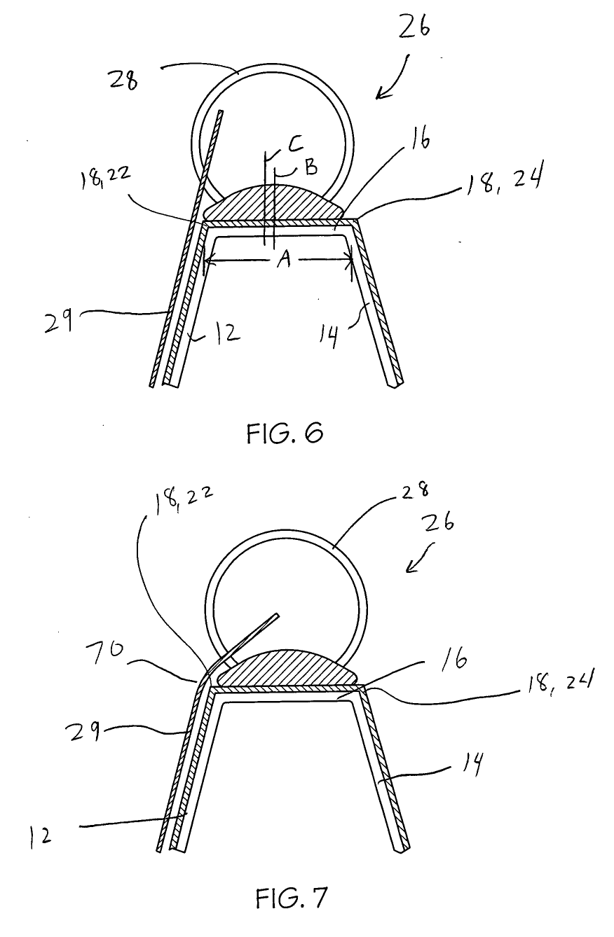

As shown in FIG. 6, the binding mechanism 26 may be offset relative to the spine 16. In particular, the binding mechanism 26 may be coupled to the spine 16 such that the binding mechanism 26 is located closer to edge 22 than to edge 24. In other words, the spine 16 may be a generally longitudinal panel which has a lateral width and the binding mechanism 26 may not be centered along the lateral width A. Further, the spine may include a longitudinal centerline B and the binding mechanism 26 may include a longitudinal centerline C, which is not generally aligned with the longitudinal centerline B of the spine 16.

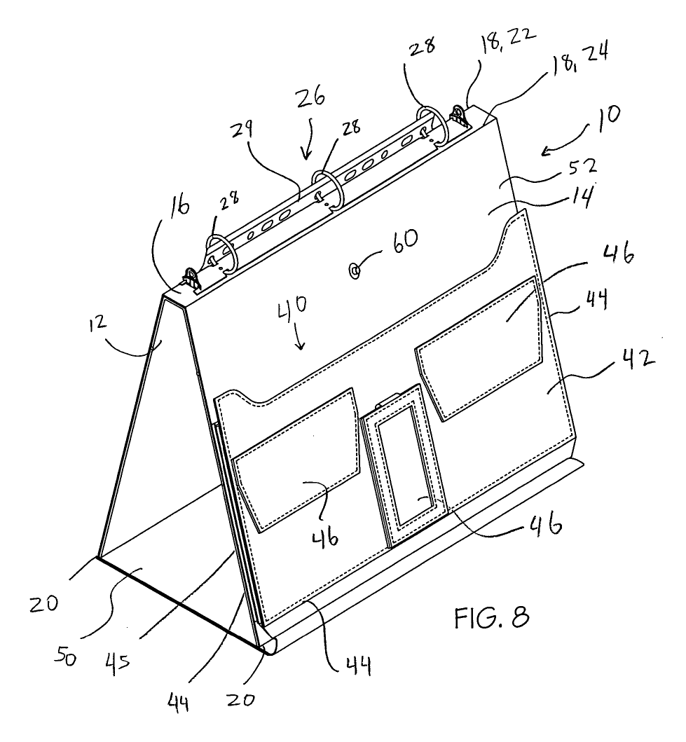

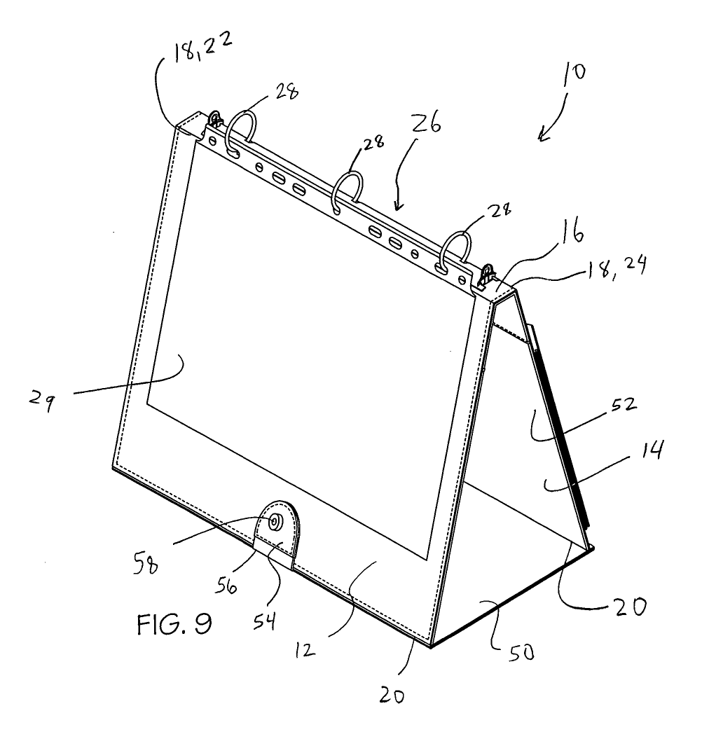

In this manner, as shown in FIG. 6, when a display sheet 29 is bound by the binding mechanism 26, the display sheet 29 lies flat against the front cover 12. If the binding mechanism 26 were to be centered along the spine 16, as shown in FIG. 7, the display sheet 29 would rest upon and fold over the junction edge 18, 22 formed between the front cover 12 and spine 14 and fold at crease 70. Thus, by locating the binding mechanism 26 closer to the edge 22 creasing of the display sheet 29 over the edge 22 is reduced which minimizes distortion of the display sheet 29. Thus, in one embodiment, the binding mechanism 26 may be located generally adjacent to the edge 22 such that a display sheet 29 bound in the binding mechanism 26 lies generally flat against and parallel with the front cover 26 (see also FIG. 9).

Having described the invention in detail and by reference to the preferred embodiments, it will be apparent that modifications and variations thereof are possible without departing from the scope of the invention.

1. A binder comprising:
a spine having a first edge and a second edge;
a front cover pivotally coupled to said first edge of said spine;
a rear cover pivotally coupled to said second edge of said spine, wherein said front cover is directly or indirectly attachable to said rear cover to form a self-supporting binder; and
a binding mechanism coupled to said spine, wherein said binding mechanism is coupled to said spine in an off-center manner such that said binding mechanism is located closer to one of said edges than the other one of said edges.

2. The binder of claim 1 wherein said spine and said covers are generally flat, planar components and are generally rectangular in front view.

3. The binder of claim 1 wherein said first and second edges are located on opposite sides of said spine.

4. The binder of claim 1 wherein said binding mechanism is a three ring binding mechanism.

5. The binder of claim 1 wherein said binder is movable between a closed position, wherein said front and rear covers are generally parallel and facing each other and said binding mechanism is generally located between said front and rear covers, and a display position wherein said front cover is directly or indirectly attached to said rear cover to form a self-supporting binder and said binding mechanism is not generally located between said front and rear covers.

6. The binder of claim 5 wherein said binder has a generally closed generally triangular shape in end view when said binder is in said display position.

7. The binder of claim 5 further comprising closure means located on said front and rear covers for retaining said binder in said closed position.

8. The binder of claim 1 wherein said rear cover includes an extension flap that is attached to said front cover when said front cover is directly or indirectly attached to said rear cover.

9. The binder of claim 8 wherein said extension flap is pivotally coupled to a main portion of said rear cover.

10. The binder of claim 8 further comprising attachment means located on said extension flap and on said front cover, wherein said attachment means can be operated to couple said extension flap to said front cover.

11. The binder of claim 10 wherein said part of said attachment means located on said front cover is located on an inner surface of said front cover.

12. The binder of claim 8 wherein said extension flap is releasably attachable to an inner surface of said rear cover.

13. The binder of claim 12 further including a pocket located on an inner surface of said rear cover.

14. The binder of claim 13 wherein said extension flap is configured such that said extension flap generally covers said pocket when said extension flap is releasably attached to said rear cover.

15. The binder of claim 1 wherein said spine is a generally longitudinal panel and has a lateral width, and wherein said binding mechanism is not centered along said lateral width.

16. The binder of claim 1 wherein said spine includes a longitudinal centerline and said binding mechanism includes a longitudinal centerline which is generally not aligned with said longitudinal centerline of said spine.

17. The binder of claim 1 wherein said binding mechanism is located generally adjacent to said one of said edges such that a display sheet bound in said binding mechanism lies generally flat and parallel with one of said front or rear covers when said binder is in a display position wherein said front cover is directly or indirectly attached to said rear cover to form a self-supporting binder.

18. The binder of claim 1 wherein said when said front cover is directly or indirectly attached to said rear cover to form a self-supporting binder wherein said binding mechanism extends generally horizontally.

19. The binder of claim 1 wherein one of said front or rear covers includes a plurality of openings to receive the outer edge of said binding mechanism therethrough.

20. The binder of claim 19 wherein each of said openings has a grommet extending around its perimeter.

21. The binder of claim 1 further comprising a plurality of sheets bound by said binding mechanism.

22. The binder of claim 1 wherein said binder is movable to a closed position, wherein said front and rear covers are generally parallel and facing each other and said binding mechanism is generally located between said front and rear covers, and wherein said binder includes closure means for retaining said binder in said closed position.

23. The binder of claim 22 wherein each cover includes an inner edge and an outer edge, each inner edge being coupled to said spine and said outer edge being located generally opposite the associated inner edge, and wherein said closure means are located generally adjacent to said outer edges.

24. A binder comprising:
a spine having a longitudinal centerline;
a front cover pivotally coupled to said spine;
a rear cover pivotally coupled to said spine, wherein said front cover is directly or indirectly attachable to said rear cover to form a self-supporting binder; and
a binding mechanism coupled to said spine and having a longitudinal centerline, wherein said binding mechanism is coupled to said spine in an off-center manner such that said longitudinal centerline of said binding mechanism is generally not aligned with said longitudinal centerline of said spine.

25. A method for manipulating a binder comprising:
providing a binder having a spine having a first edge and a second edge, a front cover pivotally coupled to said first edge of said spine, a rear cover pivotally coupled to said second edge of said spine, and a binding mechanism coupled to said spine, wherein said binding mechanism is coupled to said spine in an off-center manner such that said binding mechanism is located closer to one of said edges; and
directly or indirectly attaching said front cover to said rear cover to form a self-supporting binder.

26. The method of claim 25 wherein said attaching step includes moving said binder from a closed position, wherein said front and rear covers are generally parallel and facing each other and said binding mechanism is generally located between said front and rear covers, to a display position wherein said front cover is directly or indirectly attached to said rear cover to form a self-supporting binder and said binding mechanism is not generally located between said front and rear covers.

27. The method of claim 26 wherein said binder has a generally closed generally triangular shape in end view when said binder is in said display position.

28. The method of claim 26 wherein said binding mechanism extends generally horizontally when said binder is in said display position.

29. The method of claim 26 wherein said spine includes a longitudinal centerline and said binding mechanism includes a longitudinal centerline which is generally not aligned with said longitudinal centerline of said spine.

30. The method of claim 26 further comprising the steps of binding a plurality of pages together by said binding mechanism, and displaying said pages such that said pages lie against said front cover in a generally flat manner substantially without any creases in said pages caused by lying over a junction of said spine and one of said covers.

31. The binder of claim 1 wherein said binding mechanism is fixedly and non-rotatably coupled to said spine.

32. The binder of claim 1 wherein at least one of said front or rear cover includes attachment means that can be operated to couple front and rear covers to form said self-supporting binder.

33. The binder of claim 32 wherein said attachment means is located on both said front and rear covers.

34. The binder of claim 24 wherein said binding mechanism is fixedly and non-rotatably coupled to said spine.

35. The binder of claim 24 wherein at least one of said front or rear cover includes attachment means that can be operated to couple front and rear covers to form said self-supporting binder.

36. The binder of claim 35 wherein said attachment means is located on both said front and rear covers.

37. The method of claim 25 wherein said binding mechanism is fixedly and non-rotatably coupled to said spine.

38. The method of claim 25 wherein at least one of said front or rear cover includes attachment means that can be operated to couple front and rear covers to form said self-supporting binder.

39. The method of claim 38 wherein said attachment means is located on both said front and rear covers.
